(19) United States
(12) Patent Application Publication
(10) Pub. No.: US 2026/0231052 A1
(43) Pub. Date: Aug. 6, 2026

(54) POWER HEADROOM REPORTING ENHANCEMENTS

(71) Applicant: Apple Inc., Cupertino, CA (US)

(72) Inventors: Seyed Ali Akbar Fakoorian, San Diego, CA (US); Chunhai Yao, Beijing (CN); Chunxuan Ye, San Diego, CA (US); Dan Wu, Beijing (CN); Dawei Zhang, Saratoga, CA (US); Hong He, San Jose, CA (US); Jie Cui, San Jose, CA (US); Wei Zeng, Saratoga, CA (US); Yang Tang, San Jose, CA (US)

(21) Appl. No.: 19/154,410

(22) PCT Filed: Feb. 17, 2023
(86) PCT No.: PCT/CN2023/076887

§ 371 Date: Aug. 7, 2025

(51) Int. Cl. H04W 52/36

(52) U.S. Cl. CPC H04W 52/365; H04W 52/367

(57) ABSTRACT

Disclosed are methods, systems, and computer-readable medium to perform operations including: determining, by a user equipment, to change a power class of the UE; and in response, generating a power headroom report to be reported to a base station serving the UE.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method to be performed by a user equipment (UE) served by a base station involves: determining to change a power class of the UE; and in response, generating a power headroom report to be reported to the base station.

Other versions include corresponding systems, apparatus, and computer programs to perform the actions of methods defined by instructions encoded on computer readable storage devices. These and other versions may optionally include one or more of the following features.

In some implementations, determining to change the power class involves: determining to change the power class based on at least one of: (i), a regulatory requirement, (ii) a number of active component carriers, (iii) a percentage of uplink symbols transmitted in a certain evaluation period.

In some implementations, generating the power headroom report involves including in the power headroom report an indication of a change in power due to the change in power class.

In some implementations, the change in power is equal to 0, 3, or 6 decibel-milliwatts (dBm).

In some implementations, the power headroom report includes a two bit field for signaling the indication of the change in power.

In some implementations, the indication of the change in power indicates an effective combined value of the P-MPR and the change in power.

In some implementations, the indication of the change in power indicates a pair of P-MPR and change in power values.

In some implementations, the indication of the change in power is an index value in a predetermined table of change in power values.

In some implementations, the power headroom report further includes a reserved one bit, and the indication of the change in power is in part signaled in the reserved one bit reserved.

In some implementations, the power headroom report includes a reserved one bit for signaling the indication of the change in power.

In some implementations, the power headroom report includes a single entry power headroom Medium Access Control (MAC) control element (CE).

In some implementations, the power headroom report includes a multiple entry power headroom (PHR) Medium Access Control (MAC) control element (CE).

In some implementations, the multiple entry PHR MAC CE includes a one bit flag for signaling whether a maximum UE power is signaled in the multiple entry PHR MAC CE.

In some implementations, the one bit flag signals that the maximum UE power is not signaled in the multiple entry PHR MAC CE, and an indication of a change in power due to the change in power class is signaled in up to eight bits of the multiple entry PHR MAC CE.

In some implementations, the one bit flag signals that the maximum UE power is signaled in the multiple entry PHR MAC CE, and an indication of a change in power due to the change in power class is signaled in two bits of the multiple entry PHR MAC CE.

In accordance with another aspect of the present disclosure, a method to be performed by a base station involves: receiving a power headroom report from a user equipment (UE) served by the base station; and based on the power headroom report, determining a change in power class of the UE.

Other versions include corresponding systems, apparatus, and computer programs to perform the actions of methods defined by instructions encoded on computer readable storage devices. These and other versions may optionally include one or more of the following features.

In some implementations, the method further involves determining, from the power headroom report, an indication of a change in power due to the change in power class.

In some implementations, the indication of the change in power is an index value in a predetermined table of change in power values.

In some implementations, the power headroom report is a single entry or a multiple entry power headroom (PHR) Medium Access Control (MAC) control element (CE).

In accordance with another aspect of the present disclosure, a method to be performed by a UE served by a base station involves determining to report an available power headroom for a downlink only component carrier; and in response, generating a power headroom report that includes the available power headroom.

Other versions include corresponding systems, apparatus, and computer programs to perform the actions of methods defined by instructions encoded on computer readable storage devices. These and other versions may optionally include one or more of the following features.

In some implementations, the power headroom report is a single entry power headroom (PHR) Medium Access Control (MAC) control element (CE) or multiple entry PHR MAC CE.

In some implementations, the power headroom report is triggered in response to at least one of: (i) a change in UE's power class on configured UL CCs, (ii) the UE desires to suggest an update to the set of configured UL CC(s), (iii) a periodic timer expiring.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE FIGURES

FIG. 1A illustrates a single entry power headroom report (PHR) medium access control (MAC) control element (CE).

FIG. 1B shows a table that maps reported P-MPR values to measured quantity values.

FIG. 2 illustrates an example wireless network, according to some implementations.

FIG. 3 illustrates an example multiple entry PHR MAC-CE, according to some implementations.

FIG. 4A illustrates a flowchart of an example method, according to some implementations.

FIG. 4B illustrates a flowchart of another example method, according to some implementations.

FIG. 4C illustrates a flowchart of yet another example method, according to some implementations.

FIG. 5 illustrates an example user equipment (UE), according to some implementations.

FIG. 6 illustrates an example access node, according to some implementations.

### DETAILED DESCRIPTION

In wireless communication systems, a user equipment (UE) can send a power headroom report (PHR) to a serving base station. The PHR indicates the amount of transmission power available for the UE to use (in addition to the power currently used by the UE). The PHR also provides the serving base station with a UE configured maximum output power (P_{CMAX,f,c}) for carrier “f” of serving cell “c.” The PHR can be transmitted in a dedicated medium access control (MAC) control element (CE). The MAC CE can be a single entry PHR MAC CE or a multiple entry PHR MAC CE. The UE uses the multiple entry PHR MAC CE when operating in Multi-RAT Dual Connectivity (MR-DC) or uplink (UL) carrier aggregation (CA). The wireless configuration system can configure the UE to send the PHR in certain scenarios, such as when a specific timer expires.

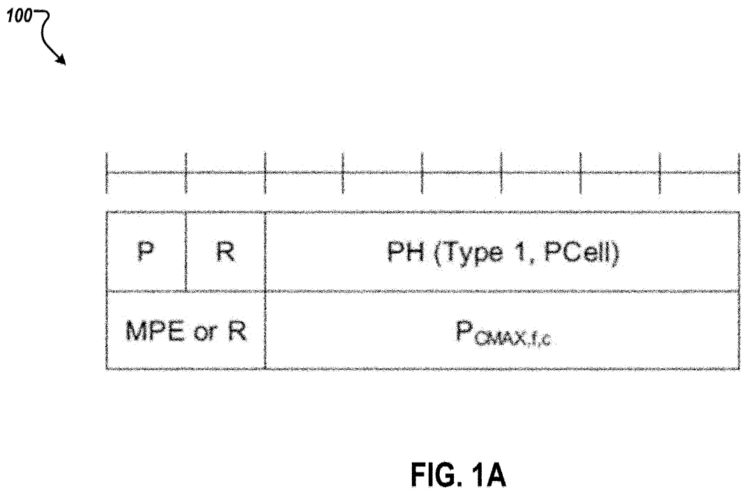

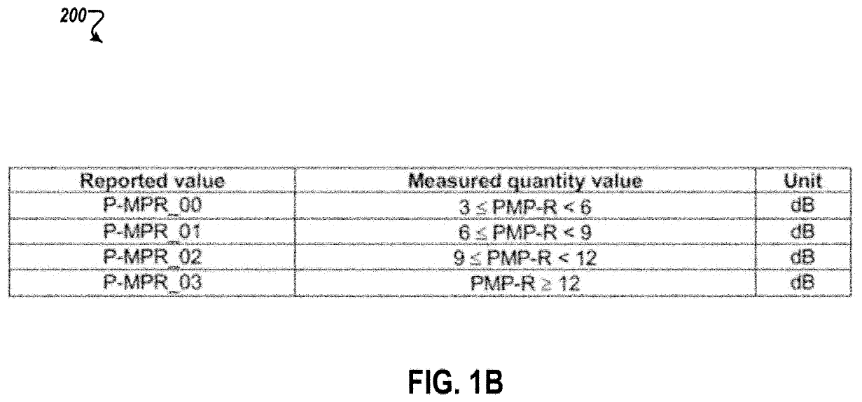

FIG. 1A illustrates a single entry PHR MAC CE 100. As shown in FIG. 1A, the single entry PHR MAC CE 100 includes two octets (eight bits each). The single entry PHR MAC CE 100 includes a one-bit “P” field, a one-bit reserved (“R”) field, a six-bit power headroom (PH) field, a two-bit maximum power exposure (MPE) field, and a six-bit P_{CMAX} field. The PH field is a six-bit field that indicates a PH level. The P_{CMAX} field indicates a value of P_{CMAX,f,c} used for calculating the preceding PH field. The configured maximum output power P_{CMAX,f,c} is set within the following bounds:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{R x S R S} , P - {MPR}_{c} ) \}$$

$${P}_{CMAX \_ H , f , c} = MIN \{ {P}_{EMAX , c} , {P}_{PowerClass} - Δ {P}_{PowerClass} \}$$

In these bounds, P_{PowerClass} is a power class of the UE (e.g., as specified in Table 6.2.1-1 of Third Generation Partnership Project [3GPP] Technical Specification [TS]38.101 without taking into account the tolerance specified in the table). ΔP_{PowerClass} is the change in power due to a power class change and can take values of {6,3,0}dB depending on several factors, such as the supported power class. As shown in FIG. 1A, only P_{CMAX,f,c} is reported to the base station (and not ΔP_{PowerClass}).

The MPE field includes a power management maximum power reduction (P-MPR) value. Note that in existing technical specifications, the UE is configured to use the MPE field only in Frequency Range 2 (FR2) and not for FR1. The P field indicates whether P-MPR is reported in the MPE field or not. For example, the P field set to one indicates that the MPE field includes P-MPR, and the P field set to zero indicates that the MPE field does not include P-MPR.

FIG. 1B shows a table 120 that maps reported P-MPR values to measured quantity values. As shown in FIG. 1B, because the MPE field is two bits, there are four possible P-MPR values, each of which corresponds to a respective measured quantity value. The table 120 corresponds to Table 10.1.26.1-1 in 3GPP TS 38.133. Note that PHR reporting is described in more detail in 3GPP TSs 38.101, 38.133, 38.321, and 38.213.

Recently, the industry has introduced high power user equipment (HPUE), which are devices that can operate using a maximum transmit power greater than a default power defined by 3GPP. Currently, the default power class, called “power class 3” (PC3), has a maximum transmit power level of less than or equal to 23 decibel-milliwatts (dBm). Some HPUEs can operate using a maximum transmit power of 26 dBm, which corresponds to “power class 2” (PC2). These HPUEs can operate using PC3 or PC2, and can switch between the different classes for various reasons. Other HPUEs can also operate using a maximum transmit power of 29 dBm, which corresponds to “power class 1.5” (PC1.5). These HPUEs can operate using PC3 or PC1.5. Some of these HPUEs can also operate using PC2.

Currently, a UE can change its power class for various reasons. One of these reasons is a determination based on the percentage of uplink symbols transmitted in a certain evaluation period (no less than one radio frame). This evaluation period, however, is up to UE implementation, and therefore, the wireless network may not be aware of the evaluation period. One consequence of the wireless network not knowing the evaluation period is that the network does not know when the UE changes its power class based on the evaluation period. Even though the wireless network can later determine that the UE's maximum transmit power has changed (e.g., from a received PHR), the wireless network cannot determine whether the power changed due to the UE changing its power class or for some other reason (e.g., path loss). Further, existing wireless networks do not have any mechanism for reporting changes in the UE's power class, whether the change was based on the evaluation period or some other reason (e.g., regulatory requirements). As a result, the wireless network can adjust operating configurations to respond to the change in the UE's power class. This can lead to inefficiencies in operating the wireless network.

Among other things, this disclosure describes methods and systems for indicating a UE's power class change to a base station of a wireless network. As described in more detail below, the disclosed methods and systems configure a UE to send a PHR in response to a power class change. Additionally, the disclosed methods and systems configure the UE to provide information indicative of the change in power due to a power class change (ΔP_{PowerClass}).

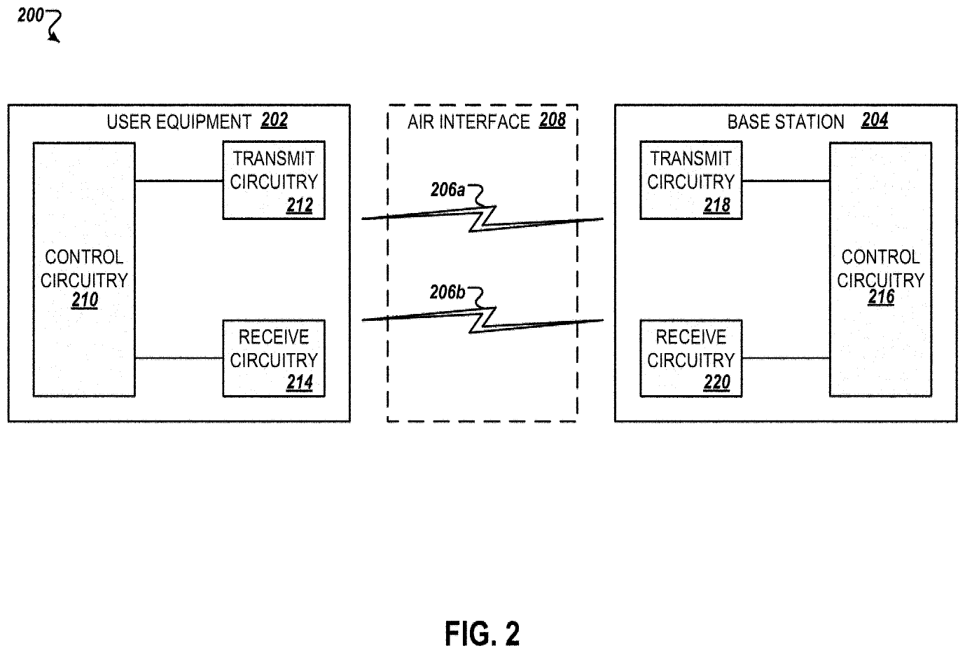

FIG. 2 illustrates a wireless network 200, according to some implementations. The wireless network 200 includes a UE 202 and a base station 204 connected via one or more channels 206A, 206B across an air interface 208. The UE 202 and base station 204 communicate using a system that supports controls for managing the access of the UE 202 to a network via the base station 204.

In some implementations, the wireless network 200 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 200 may be a E-UTRA (Evolved Universal Terrestrial Radio Access)-NR Dual Connectivity (EN-DC) network, or a NR-EUTRA Dual Connectivity (NE-DC) network. However, the wireless network 200 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.1 lac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 200, the UE 202 and any other UE in the system may be, for example, laptop computers, smartphones, tablet computers, machine-type devices such as smart meters or specialized devices for healthcare, intelligent transportation systems, or any other wireless devices with or without a user interface. In network 200, the base station 204 provides the UE 202 network connectivity to a broader network (not shown). This UE 202 connectivity is provided via the air interface 208 in a base station service area provided by the base station 204. In some implementations, such a broader network may be a wide area network operated by a cellular network provider, or may be the Internet. Each base station service area associated with the base station 204 is supported by antennas integrated with the base station 204. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 202 includes control circuitry 210 coupled with transmit circuitry 212 and receive circuitry 214. The transmit circuitry 212 and receive circuitry 214 may each be coupled with one or more antennas. The control circuitry 210 may include various combinations of application-specific circuitry and baseband circuitry. The transmit circuitry 212 and receive circuitry 214 may be adapted to transmit and receive data, respectively, and may include radio frequency (RF) circuitry or front-end module (FEM) circuitry.

In various implementations, aspects of the transmit circuitry 212, receive circuitry 214, and control circuitry 210 may be integrated in various ways to implement the operations described herein. The control circuitry 210 may be adapted or configured to perform various operations such as those described elsewhere in this disclosure related to a UE.

The transmit circuitry 212 can perform various operations described in this specification. Additionally, the transmit circuitry 212 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 212 may be configured to receive block data from the control circuitry 210 for transmission across the air interface 208.

The receive circuitry 214 can perform various operations described in this specification. Additionally, the receive circuitry 214 may receive a plurality of multiplexed downlink (DL) physical channels from the air interface 208 and relay the physical channels to the control circuitry 210. The plurality of downlink physical channels may be multiplexed according to TDM or FDM along with carrier aggregation. The transmit circuitry 212 and the receive circuitry 214 may transmit and receive both control data and content data (e.g., messages, images, video, etc.) structured within data blocks that are carried by the physical channels.

FIG. 2 also illustrates the base station 204. In implementations, the base station 204 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 204 that operates in an NR or 5G wireless network 200, and the term “E-UTRAN” or the like may refer to a base station 204 that operates in an LTE or 4G wireless network 200. The UE 202 utilizes connections (or channels) 206A, 206B, each of which includes a physical communications interface or layer.

The base station 204 circuitry may include control circuitry 216 coupled with transmit circuitry 218 and receive circuitry 220. The transmit circuitry 218 and receive circuitry 220 may each be coupled with one or more antennas that may be used to enable communications via the air interface 208. The transmit circuitry 218 and receive circuitry 220 may be adapted to transmit and receive data, respectively, to any UE connected to the base station 204. The transmit circuitry 218 may transmit downlink physical channels includes of a plurality of downlink subframes. The receive circuitry 220 may receive a plurality of uplink physical channels from various UEs, including the UE 202.

In FIG. 2, the one or more channels 206A, 206B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 202 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

In some implementations, the UE 202 is configured to trigger an aperiodic PHR in response to detecting a power class change. The UE 202 can change the power class to satisfy regulatory requirements (e.g., a specific absorption rate [SAR]), in response to a change in the number of active component carriers (CC) in CA/DC, and/or based on a percentage of uplink symbols transmitted in a certain evaluation period. The SAR requirement regulates the amount of RF energy absorbed by a user when operating the UE 202, and are specified by regulatory entities (e.g., the Federal Communications Commission [FCC], the European Committee for Electrotechnical Standardization [CENELEC], and so on). In some examples, the UE 202 is configured to trigger the PHR in response to any power class change. In other examples, the UE 202 is configured to trigger the PHR in response to power class changes that result from specified events (e.g., changes to satisfy regulatory requirements, etc.).

In some implementations, the UE 202 is configured to trigger a single entry PHR MAC-CE or a multiple entry PHR MAC-CE. The UE 202 can trigger the multiple entry PHR MAC-CE in scenarios where the UE 202 is operating in MR-DC or UL CA.

In some implementations, the UE 202 includes in the triggered PHR an indication of the power change that results from the power class change, ΔP_{PowerClass}. ΔP_{PowerClass} can have values of {6,3,0}dB, and therefore, the indication can indicate one of these values. The UE 202 can include the indication in either a single entry PHR MAC-CE or a multiple entry PHR MAC-CE, depending on the PHR that is triggered.

In some implementations, the UE 202 is configured with one or more approaches for reporting the indication in a single entry PHR MAC-CE (“single entry approaches”). In a first single entry approach, the UE 202 uses the P and the MPE fields of the single entry PHR MAC-CE to report the indication. The UE 202 can be configured with at least one of two options for implementing the first single entry approach.

In a first option, the UE 202 includes in the MPE field an index to an effective combined P-MPR+ΔP_{PowerClass} level (in dB). Under this option, the UE 202 is configured to use an updated version of the table 120 of FIG. 1B. Instead of mapping the value of the MPE field to P-MPR like table 120, the updated table maps P-MPR+ΔP_{PowerClass}. Alternatively, the UE 202 can be configured to use a separate table that maps a value of the MPE field to P-MPR+ΔP_{PowerClass}. As explained previously, the table 120 is only applicable for FR2 in current wireless systems. Thus, the UE 202 can be configured to use for FR1 a table similar to the table created for FR2. In a second option for implementing the first single entry approach, the UE 202 is configured to use the MPE field to indicate an index to a pair of (P-MPR, ΔP_{PowerClass}) levels in dB. In this approach, tables that map the index values pair of (P-MPR, ΔP_{PowerClass}) levels are defined for FR1 and FR2.

In some implementations, the number of rows (i.e., the number of possible indices) of the created tables in both options can be four or eight (or a number between four and eight). If the created tables include more than four rows, then the reserved (R) bit in the PHR is also used to signal the indication. The reserve bit and the MPE field provide a total of three bits for signaling the indication, and therefore, the UE 202 can signal up to eight indices. In some examples, one or more rows of a particular table can map to P-MPR or ΔP_{PowerClass} only (as opposed to a pair of values or an effective combined value).

In a second single entry approach, the UE 202 uses the reserved bit (R) for singling the indication of the power change. In this approach, setting R to 0 indicates that the power change due to the power class change is 0 dBm. And setting R to 1 indicates that the power change is not 0 (i.e., 3 or 6 dBm). If the UE 202 sets R to 1, the wireless network 200, upon receipt of the PHR, can determine whether the power change is 3 or 6 dBm. In some examples, the wireless network 200 makes the determination based on the power class (P_{PowerClass}) of the UE 202. For example, if the UE 202 is PC2, the wireless network can determine that the power change is 3 dBm.

In some implementations, the UE 202 reports ΔP_PowerClass in a multiple entry PHR MAC-CE in scenarios of CA/DC. The number of bits that are available for reporting ΔP_PowerClass depends on whether one of the entries is a PHR Type1 for a serving cell with a configured UL based on a real PUSCH transmission or for a serving cell with a configured UL based on a reference/virtual PUSCH transmission. If the PHR Type1 is for a serving cell with a configured UL based on a real PUSCH transmission, then the number of available bits is two. And if the PHR Type1 is for a serving cell with a configured UL based on a reference/virtual PUSCH transmission, then the number of available bits is eight.

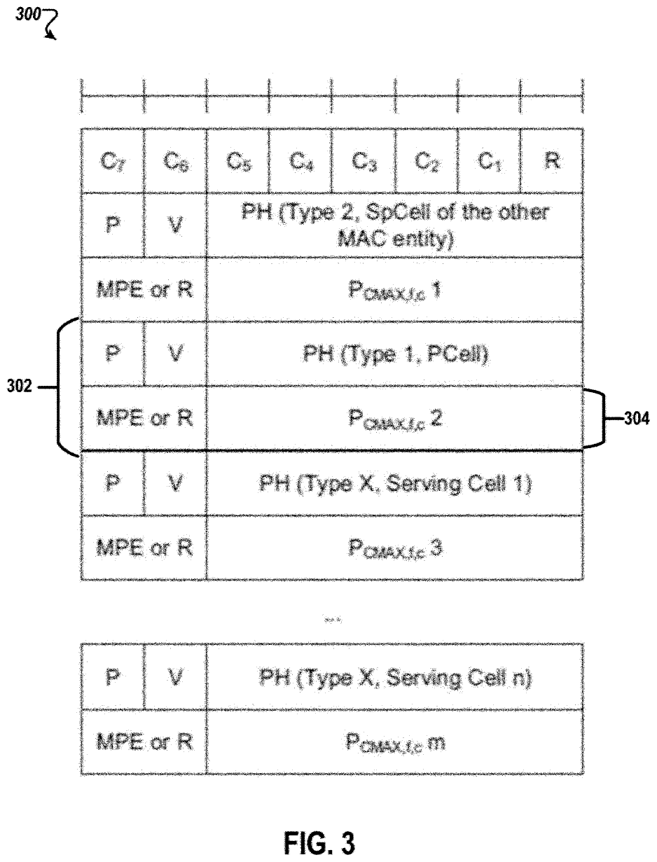

FIG. 3 illustrates an example multiple entry PHR MAC-CE 300, according to some implementations. Each octet pair in the MAC-CE 300 corresponds to a serving cell or component carrier that is included in the report. That is, each octet pair is a single entry in the multiple entry PHR MAC-CE 300. For example, octet pair 302 corresponds to a primary cell (PCell) that is included in the report. Each octet pair is similar to the single entry PHR MAC-CE 100 of FIG. 1A. Specifically, each octet pair includes a PH filed, a “P” field, an MPE field, and P_{CMAX} field. The reserved bit of the MAC-CE 100, however, is replaced with a “V” field. This field indicates whether the PH result is based on a real PUSCH transmission or a reference/virtual PUSCH transmission. For example, V is set to 0 for a PH result based on a real PUSCH transmission and is set to 1 for a PH result based on a reference/virtual PUSCH transmission. The V field also indicates whether or not a P_{CMAX} value is included in the corresponding octet. A P_{CMAX} value is only included when the PH result is based on a real PUSCH transmission.

In some implementations, when the value of V for a particular octet pair is 0, only the P and MPE bit fields can be used to indicate both P-MPR and ΔP_{PowerClassCA} (because the corresponding P_{CMAX} is included). In these implementations, the UE 202 can implement a similar approach to the first single entry approach. Specifically, the UE 202 can use the MPE field to include an indication of an effective combined P-MPR+ΔP_{PowerClass} level (Option 1) or can use the MPE field to indicate a pair of (P-MPR, ΔP_{PowerClass}) levels (Option 2). In these implementations, however, the table size is limited to 4 rows (as the available bit size is limited to two since the reserved bit is no longer available).

In some implementations, when the value of V for a particular octet pair is 1, the second octet in the pair can be used to indicate P-MPR and ΔP_{PowerClassCA}. For example, in the octet pair 302, a second octet 304 can be used to indicate P-MPR and ΔP_{PowerClassCA}. The entire octet is available for use because P_{cmax} is not reported when V is set to 1. In these implementations, the UE 202 can implement a similar approach to the first single entry approach. Specifically, the UE 202 can use the MPE field to include an indication of an effective combined P-MPR+ΔP_{PowerClass} level (Option 1) or can use the MPE field to indicate a pair of (P-MPR, ΔP_{PowerClass}) levels (Option 2). In these implementations, however, the table size can be more than 8 rows (as the number of available bits is 8).

This disclosure also describes systems and methods that enable the UE 202 to assist the base station 204 in selecting a band combination and/or a preferred UL CCs. Typically in a CA scenario, a UE is configured with more CCs in DL-CA, and only few of these CCs may be used for UL (in UL-CA or even non-CA mode). Under some conditions, like SAR regulatory requirements, the UE may know better than wireless network which CCs are better to be configured for UL.

In some implementations, the UE 202 is configured to signal to the base station 204 information indicative of a CC to use for the UL. In some implementations, the UE 202 is configured to report a PHR MAC CE to indicate available power headroom for a DL only CC (e.g., a CC not configured for UL). In a first option, the report is based on a single entry PHR MAC-CE, with one or more octets that carry the following information: (i) log 2(N) bits to indicate the ServCellIndex of the DL only CC with the best available power for UL transmission, where N represents number of DL only CCs, and (ii) M bits (e.g., M=6) to indicate PH (Type 1) for the corresponding DL only CC. In a second option, the report is based on a multiple entry PHR MAC-CE, with one or more octets that carry the respective PH for each of the DL only CCs. Note that in both options, the report is based on virtual/reference PUSCH, given that the corresponding CC is not configured for UL. Thus, the P_{CMAX} field and the MPE field are available to be used for reporting.

In some implementations, the UE 202 is configured to trigger the downlink CC PHR in response to observing a change in the UE's power class on configured UL CCs, in response to determining to provide an update to the set of configured UL CC(s), and/or in a periodic manner.

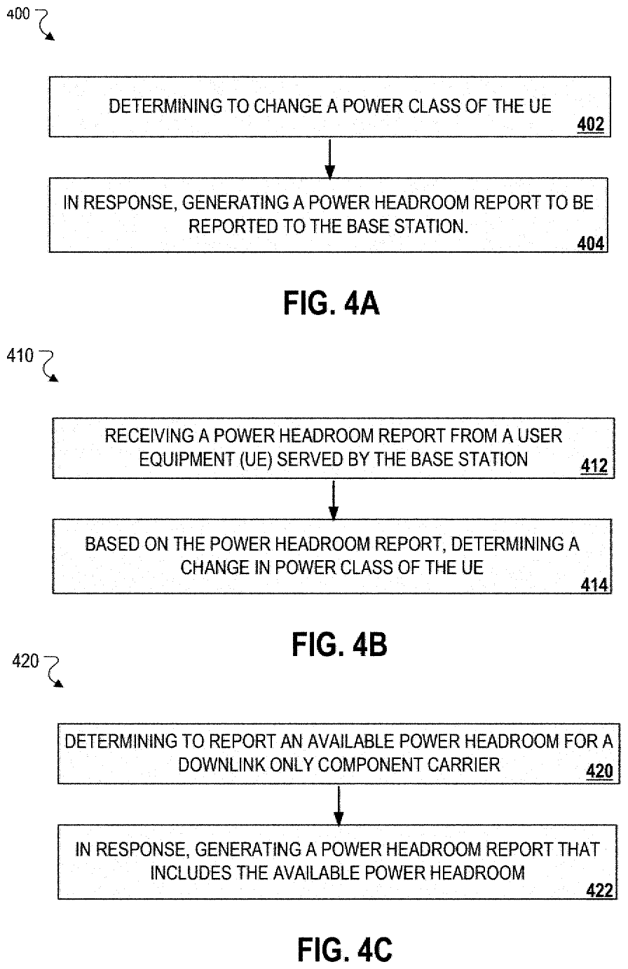

FIG. 4A illustrates a flowchart of an example method 400, according to some implementations. For clarity of presentation, the description that follows generally describes method 400 in the context of the other figures in this description. For example, method 400 can be performed by UE 202 of FIG. 2. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At step 402, method 400 involves determining to change a power class of the UE.

At step 404, method 400 involves in response, generating a power headroom report to be reported to the base station.

In some implementations, determining to change the power class involves: determining to change the power class based on at least one of: (i), a regulatory requirement, (ii) a number of active component carriers, (iii) a percentage of uplink symbols transmitted in a certain evaluation period.

In some implementations, generating the power headroom report involves: including in the power headroom report an indication of a change in power due to the change in power class.

In some implementations, the change in power is equal to 0, 3, or 6 decibel-milliwatts (dBm).

In some implementations, the power headroom report includes a two bit field for signaling the indication of the change in power.

In some implementations, the indication of the change in power further indicates a Power Management Maximum Power Reduction (P-MPR) value.

In some implementations, the indication of the change in power is an index value in a predetermined table of change in power values.

In some implementations, the power headroom report further includes a reserved one bit, and the indication of the change in power is in part signaled in the reserved one bit reserved.

In some implementations, the power headroom report includes a reserved one bit for signaling the indication of the change in power.

In some implementations, the power headroom report includes a single entry power headroom Medium Access Control (MAC) control element (CE).

In some implementations, the power headroom report includes a multiple entry power headroom (PHR) Medium Access Control (MAC) control element (CE).

In some implementations, the multiple entry PHR MAC CE includes a one bit flag for signaling whether a maximum UE power is signaled in the multiple entry PHR MAC CE.

In some implementations, the one bit flag signals that the maximum UE power is not signaled in the multiple entry PHR MAC CE, and where an indication of a change in power due to the change in power class is signaled in up to eight bits of the multiple entry PHR MAC CE.

In some implementations, the one bit flag signals that the maximum UE power is signaled in the multiple entry PHR MAC CE, and where an indication of a change in power due to the change in power class is signaled in two bits of the multiple entry PHR MAC CE.

FIG. 4B illustrates a flowchart of an example method 410, according to some implementations. For clarity of presentation, the description that follows generally describes method 410 in the context of the other figures in this description. For example, method 410 can be performed by base station 204 of FIG. 2. It will be understood that method 410 can be performed, for example, by any suitable system, environment, software, hardware, or a combination of systems, environments, software, and hardware, as appropriate. In some implementations, various steps of method 410 can be run in parallel, in combination, in loops, or in any order.

At step 412, method 410 involves receiving a power headroom report from a user equipment (UE) served by the base station.

At step 414, method 410 involves based on the power headroom report, determining a change in power class of the UE.

In some implementations, determining, from the power headroom report, an indication of a change in power due to the change in power class.

In some implementations, the indication of the change in power is an index value in a predetermined table of change in power values.

In some implementations, the power headroom report is a single entry or a multiple entry power headroom (PHR) Medium Access Control (MAC) control element (CE).

FIG. 4C illustrates a flowchart of an example method 420, according to some implementations. For clarity of presentation, the description that follows generally describes method 420 in the context of the other figures in this description. For example, method 420 can be performed by UE 202 of FIG. 2. It will be understood that method 420 can be performed, for example, by any suitable system, environment, software, hardware, or a combination of systems, environments, software, and hardware, as appropriate. In some implementations, various steps of method 420 can be run in parallel, in combination, in loops, or in any order.

At step 422, method 420 involves determining to report an available power headroom for a downlink only component carrier.

At step 424, method 420 involves in response, generating a power headroom report that includes the available power headroom.

In some implementations, the power headroom report is a single entry power headroom (PHR) Medium Access Control (MAC) control element (CE) or multiple entry PHR MAC CE.

In some implementations, the power headroom report is triggered in response to at least one of: (i) a change in UE's power class on configured UL CCs, (ii) the UE desires to suggest an update to the set of configured UL CC(s), (iii) a periodic timer expiring.

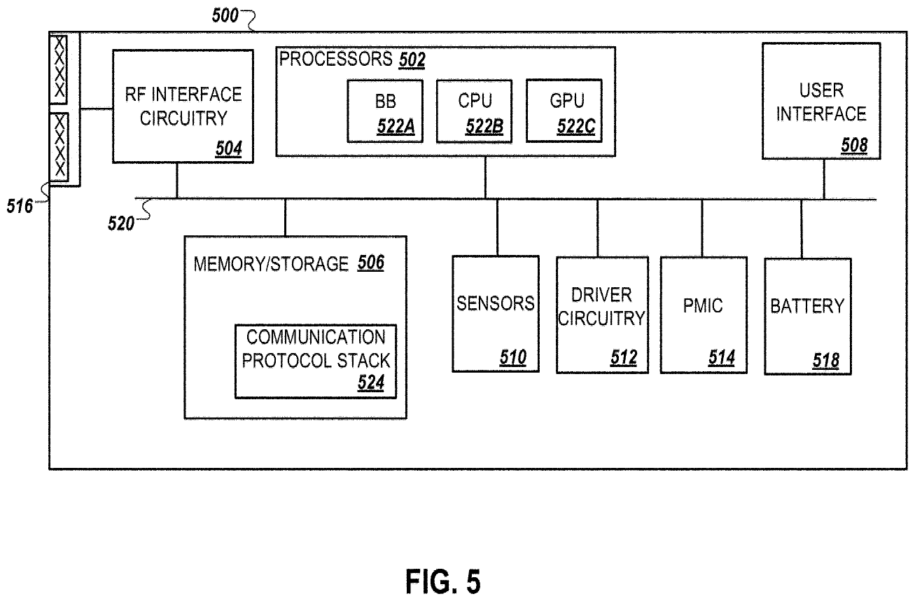

FIG. 5 illustrates an example UE 500, according to some implementations. The UE 500 may be similar to and substantially interchangeable with UE 202 of FIG. 2.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, one or more antenna(s) 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, one or more of the processors 502 are configured to determine to change a power class of the UE. Further, the one or more of the processors 502 are configured to generate a power headroom report to be reported to the base station. In some implementations, one or more of the processors 502 are configured to determine to report an available power headroom for a downlink only component carrier. Further, the one or more of the processors 502 are configured to, in response, generate a power headroom report that includes the available power headroom.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensors 510 and control and allow access to sensors 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

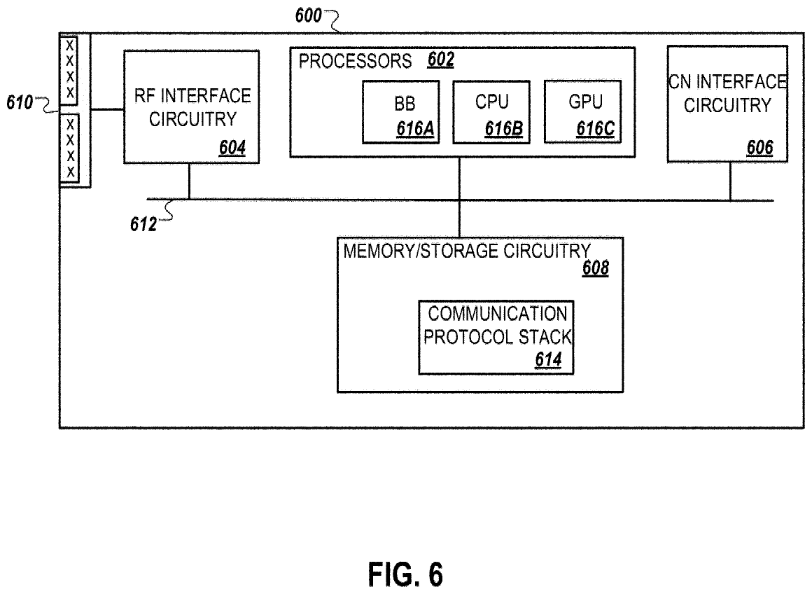

FIG. 6 illustrates an example access node 600 (e.g., a base station or gNB), according to some implementations. The access node 600 may be similar to and substantially interchangeable with base station 204. The access node 600 may include processors 602, RF interface circuitry 604, core network (CN) interface circuitry 606, memory/storage circuitry 608, and one or more antenna(s) 610.

The components of the access node 600 may be coupled with various other components over one or more interconnects 612. The processors 602, RF interface circuitry 604, memory/storage circuitry 608 (including communication protocol stack 614), antenna 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

In some implementations, one or more of the processors 602 are configured to determine to report an available power headroom for a downlink only component carrier. Further, the one or more of the processors 602 are configured to generate a power headroom report that includes the available power headroom.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
determining to change a power class of a user equipment (UE);
generating, in response to the change in the power class of the UE, a power headroom report to include an indication of a change in power; and
transmitting the power headroom report to a base station.

2. The method of claim 1, wherein determining to change the power class comprises:
determining to change the power class based on at least one of: (i), a regulatory requirement, (ii) a number of active component carriers, (iii) a percentage of uplink symbols transmitted in a certain evaluation period.

3. (canceled)

4. The method of claim 1, wherein the change in power is equal to 0, 3, or 6 decibel-milliwatts (dBm).

5. The method of claim 1, wherein the power headroom report comprises a two bit field for signaling the indication of the change in power.

6. The method of claim 5, wherein the indication of the change in power further indicates a Power Management Maximum Power Reduction (P-MPR) value.

7. The method of claim 6, wherein the indication of the change in power indicates an effective combined value of the P-MPR and the change in power.

8. The method of claim 6, wherein the indication of the change in power indicates a pair of P-MPR and change in power values.

9. The method of claim 5, wherein the indication of the change in power is an index value in a predetermined table of change in power values.

10. The method of claim 5, wherein the power headroom report further comprises a reserved one bit, and wherein the indication of the change in power is in part signaled in the reserved one bit.

11. The method of claim 1, wherein the power headroom report comprises a reserved one bit for signaling the indication of the change in power.

12. The method of claim 1, wherein the power headroom report comprises a single entry power headroom Medium Access Control (MAC) control element (CE).

13. The method of claim 1, wherein the power headroom report comprises a multiple entry power headroom (PHR) Medium Access Control (MAC) control element (CE).

14. The method of claim 13, wherein the multiple entry PHR MAC CE comprises a one bit flag for signaling whether a maximum UE power is signaled in the multiple entry PHR MAC CE.

15. The method of claim 14, wherein the one bit flag signals that the maximum UE power is not signaled in the multiple entry PHR MAC CE, and wherein an indication of a change in power due to the change in power class is signaled in up to eight bits of the multiple entry PHR MAC CE.

16. The method of claim 14, wherein the one bit flag signals that the maximum UE power is signaled in the multiple entry PHR MAC CE, and wherein an indication of a change in power due to the change in power class is signaled in two bits of the multiple entry PHR MAC CE.

17-25. (canceled)

26. The method of claim 1, wherein the indication of the change in power is represented by ΔP_{PowerClass}.

27. The method of claim 13, the power headroom report further comprises an additional indication of a change in power for a band combination for carrier aggregation.

28. The method of claim 27, wherein the additional indication of the change in power for the band combination is represented by ΔP_{PowerClassCA}.

29. One or more processors configured to perform operations, the operations comprising:
determining to change a power class of a user equipment (UE);
generating, in response to the change in the power class of the UE, a power headroom report to include an indication of a change in power; and
causing a transmission of the power headroom report to a base station.

30. A user equipment (UE) comprising:
a memory;
a transceiver; and
a processor coupled to the memory and configured to, when executing instructions stored in the memory, cause the UE to:
determine to change a power class of a user equipment (UE);
generate, in response to the change in the power class of the UE, a power headroom report to include an indication of a change in power; and
transmit the power headroom report to a base station.
